(19) United States
(12) Patent Application Publication
(10) Pub. No.: US 2016/0217272 A1
(43) Pub. Date: Jul. 28, 2016

(54) METHOD FOR PROVIDING A MEDICATION NOTIFICATION TO A PATIENT

(71) Applicants: Philippe Panzini, Westmount (CA); Hugo Tetreault, Outremont (CA); Robert Kulis, The Woodlands, TX (US)

(72) Inventors: Philippe Panzini, Westmount (CA); Hugo Tetreault, Outremont (CA); Robert Kulis, The Woodlands, TX (US)

(21) Appl. No.: 15/007,151

(22) Filed: Jan. 26, 2016

Related U.S. Application Data
(60) Provisional application No. 62/108,126, filed on Jan. 27, 2015.

(51) Int. Cl. G06F 19/00

(52) U.S. Cl. CPC G06F 19/3462

(57) ABSTRACT

A method for providing a patient with a medication notification through the use of an electronic device comprising at least one locus onto which a medical container, which comprises a Radio Frequency (RF) component comprising medication data, is placed. In certain embodiments, the medication notification is displayed on a remote electronic device, such as a smartphone or tablet, which wirelessly connects to the electronic device.

### BACKGROUND

1. Field

This patent application relates to a method for providing a medication notification to a patient.

2. Background Information

In the United States and around the world there are a large number of people that are living longer than in previous generations. This has led to a growing, number of aging individuals that require medication and many of those individuals often require multiple medications that are to he taken at different time intervals. To compound this issue, some individuals, such as the elderly, find it difficult to not only remember when they are to take their medication but they also find prescription directions confusing and difficult to interpret. While there are tools that exist to assist patients with managing their medications, these tools are often cumbersome and confusing. Accordingly, there exists a need for a system that can alleviate the inherent shortcomings in the tools and processes that are currently available to a patient.

### SUMMARY

In accordance with one embodiment, a method for providing a medication notification to a patient comprising: placing a medical container comprising a Radio Frequency (RF) component onto an electronic device, wherein said Radio Frequency (RF) component comprises medication data regarding a medication contained within the medical container and wherein said electronic device comprises: (i) a locus for positioning the medical container, (ii) a measurement sensor for determining the weight of the medication, (iii) one or more processors configured to trigger and manage a reading of the measurement sensor to create measurement data regarding the amount of medication in the medical container, (iv) a transmitter for wirelessly transmitting the measurement data and the medication data, (v) a RF reader/writer module configured to receive the medication data, and, optionally, at least one of the following: an audio speaker or a light source; creating measurement data regarding the amount of medication within the medical container; reading the medication data from the Radio Frequency (RF) component; transmitting the measurement data and the medication data to a remote electronic device wherein the remote electronic device comprises: (a) a wireless receiver configured to receive the measurement data; (b) one or more processors configured to determine a medication schedule and activate a medication alert based at least in part on the measurement data and the medication data (c) a display; (d) a wireless receiver configured to receive the medication data from the electronic device, and, optionally, at least one of the following: an audio speaker or a light source; determining a medication schedule based at least in part on the measurement data and the medication data; and activating the medication alert when the patient is required to take the medication as determined by the medication schedule, wherein the medication alert comprises activating at least one of the light source, the audio speaker, or component (c) on the remote electronic device and, optionally, activating at least one of the speaker or the light source on the electronic device.

In accordance with another embodiment, a method for providing a medication notification to a patient comprising: placing a medical container comprising a Radio Frequency (RF) component onto an electronic device, wherein said Radio Frequency (RE) component comprises medication data regarding a medication contained within the medical container and wherein said electronic device comprises: (i) a locus for positioning the medical container, (ii) a measurement sensor for determining the weight of the medication, (iii) one or more processors configured to trigger and manage a reading of the measurement sensor to create measurement data regarding the amount of medication in the medical container, (iv) a transmitter for wirelessly transmitting the measurement data and the medication data, optionally, at least one of the following: an audio speaker or a light source; creating measurement data regarding the amount of medication within the medical container; using a remote electronic device to read the measurement and medication data from the electronic device wherein the remote electronic device comprises: (a) a wireless receiver configured to receive the measurement data; (b) one or more processors configured to determine a medication schedule and activate a medication alert based at least in part on the measurement data and the medication data; (c) a display; (d) a RF reader/writer module configured to receive the medication data, and, optionally, at least one of the following; an audio speaker or a light source; reading the medication data from the Radio Frequency (RF) component; determining a medication schedule based at least in part on the measurement data and the medication data: and activating the medication alert when the patient is required to take the medication as determined by the medication schedule, wherein the medication alert comprises activating at least one of the light source, the audio speaker, or component (c) on the remote electronic device and, optionally, activating at least one of the speaker or the light source on the electronic device.

### BRIEF DESCRIPTION OF THE DRAWINGS

A full understanding of the invention can be gained from the following description of certain embodiments of the invention when read in conjunction with the accompanying drawings in which:

FIG. 1 depicts one embodiment of the medical container.

FIG. 2 depicts one embodiment of the electronic device.

FIG. 2a depicts another embodiment of the electronic device of FIG. 2.

FIG. 3 is a cross-section of the electronic device of FIG. 2 along Line 2-1.

FIG. 4 is another embodiment of the electronic device depicted in FIG. 2.

FIG. 5 is another embodiment of the electronic device.

FIG. 5A is a cross section of the electronic device of FIG. 5 along Line 5-1.

FIG. 6 is another embodiment of the electronic device depicted in FIG. 5.

FIG. 7 is another embodiment of the electronic device.

FIG. 8 is a schematic of one embodiment of the electronic device.

FIG. 9 is a schematic of one embodiment of the remote electronic device.

FIG. 10 depicts an electronic device connected to a remote data network.

FIG. 11 is a flow diagram of one embodiment and the steps taken when a medical container is introduced into the electronic device.

FIG. 12 is a flow diagram of one embodiment of the calibration module.

FIG. 13 is a flow diagram of one embodiment of the creation of the medication schedule.

### DETAILED DESCRIPTION

As used herein, unless otherwise expressly specified, all numbers such as those expressing values, ranges, amounts or percentages may be read as if prefaced by the word “about”, even if the term does not expressly appear. Plural encompasses singular and vice versa.

As used herein, “plurality” means two or more

As used herein, “includes” and like terms means “including without limitation.”

As used herein, the term “module” refers to software, hardware, or firmware (or any combination thereof) components. Modules are functional components that can generate data or other output using specified inputs. A module may or may not be self-contained. By way of illustration, an application program (also called an “application”) may include one or more modules, or a module can include one or more application programs.

When referring to any numerical range of values, such ranges are understood to include each and every number and/or fraction between the stated range minimum and maximum. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Directional phrases used herein, such as, for example, upper, lower, left, right, vertical, horizontal, top, bottom, above, beneath, clockwise, counterclockwise and derivatives thereof, relate to the orientation of the elements shown in the drawings and are not limiting upon the claims unless expressly recited therein.

### Medical Container

The medical container that is used in conjunction with the disclosed method can be any medical container that is used in the pharmaceutical industry to store a patient's medication such as the patient's prescriptive pills. Illustrative examples of the medical container include, without limitation, glass vials and bottles, plastic vials and bottles, and metal, paper, or plastic containers. In certain embodiments, the medical container would have a dram size ranging from ¼ to 60. The cross-sectional shape of the medical container can be a circle, oval, square, or rectangle.

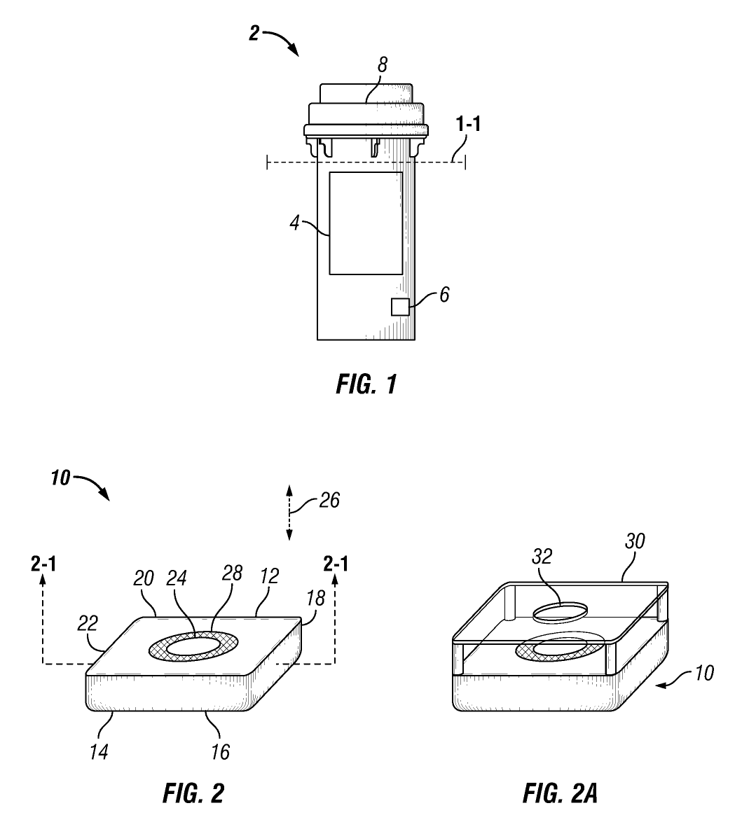

In the embodiment shown in FIG. 1, the medical container 2 is a metal or plastic vial having a circular cross-sectional shape alone line 1-1. The medical container 2 comprises a printed label 4 and Radio Frequency (RF) component 6.

The printed label 4 contains information related to the patient and the contents of the medical container 2. For example, in some embodiments, the printed label 4 typically comprises the patient's name as well as the name of the medication that is stored within the medical container 2. Other information, such as the number of prescriptive pills/tablets contained within the medical container 2 and recommended dosage information, may be printed on the printed label 4 as well.

The Radio Frequency (RF) component 6 is a module that is configured to store data/information in addition to being configured to wirelessly transmit the stored information to another device. Illustrative examples of the Radio Frequency (RF) component 6 are Near Field Communication (NFC), Ultra High Frequency (UHF), and Radio Frequency identification (RFID) transponder chips, or combinations thereof. The information stored in the Radio Frequency (RF) component 6 is only limited by the maximum capacity of the Radio Frequency (RF) component 6. In other words, any type of information can be stored in the Radio Frequency (RF) component provided that the information does not exceed the maximum storage amount of the Radio Frequency (RF) component 6. In certain embodiments, patient information (e.g., known allergies), patient related information (e.g., physician name and phone number), medication information (e.g., known adverse reactions with other medications), and prescription data (e.g., dosage information), or combinations thereof is stored on the Radio Frequency (RF) component 6. In some embodiments, the information stored in the Radio Frequency (RF) component 6 can be updated using a component, such as a RF writer module, which is configured to update the information on the Radio Frequency (RF) component 6. Accordingly, as updated information regarding the medication becomes available, the information that is stored in the Radio Frequency (RF) component 6 can be updated thereby allowing the patient to have the most current information with regard to the medication in the medical container 2. In certain embodiments, the RF writer module can be a combination RF reader/writer module.

In the embodiment shown in FIG. 1, the medical container 2 also comprises a cap 8, such as a twist on safety cap, to ensure that the content of the medical container 2 does not spill out of the medical container 2 while keeping children from accessing the medication stored within the medical container 2.

### Electronic Device

Referring to FIG. 2, in this embodiment the electronic device 10 comprises a first surface 12, a second surface 14, a first side 16, a second side 18, a third side 20, and a fourth side 22. Positioned on the first surface 12 is a single locus 24 onto which the medical container 2 may be placed. In certain embodiments, the first surface 12, excluding the locus 24, is a single piece of material. For example, the first surface 12 can be manufactured from glass or plastic. In these embodiments, there will be cutouts for the locus 14 in the first surface 12. In certain embodiments, all or at least a portion of the perimeter of the locus 24 is horizontally offset from the first surface 12 thereby defining the locus 24 from the rest of the first surface 12 of the electronic device 10. In these embodiments, all or at least a portion of the perimeter of the locus 24 is not connected or attached to the first surface 12 of the electronic device 10. Because the locus 24 is horizontally offset from the first surface 12 in these embodiments, the locus 24 can travel vertically in the direction of arrow 26 when a medical container 2 is placed on the locus 24. In other embodiments, however, the locus 24 is stationary and does not travel vertically in the direction of arrow 26. In yet other embodiments, the locus 24 is not only offset from the first surface 12 horizontally, but it can also be vertically offset from the first surface 12.

Referring to FIG. 2, in this embodiment the locus 24 has a circular shape and is adapted to accept a medical container 2 having a circular cross-sectional shape. However, the shape of the locus 24 is limited only by the shape of the medical container 2 that is used by the patient. Accordingly, the locus 24 can also have an oval, square, or rectangular shape as well. In order to assist the patient with positioning the medical container 2 onto the locus 24, indicia 28 may be placed around all or a portion of the locus 24. In certain embodiments, the indicia 28 outlines or surrounds all or substantially all of the locus' 24 perimeter. In other embodiments, the indicia 28 outlines or surrounds only a part of the locus' 24 perimeter. In order to further assist the patient with positioning the medical container 2 onto the locus 24, a visual indicator, such as a light, might be used in conjunction with the indicia 28. For example, the light might be positioned under the indicia 24 thereby providing a backlight to the indicia 28 or the light might be positioned around all or a portion of the indicia.

Referring to FIG. 2a, in this embodiment, a removable guide 30 is place over the first surface 12 of the electronic device 10. The guide 30 is another aid to assist the patient in placing the medical container 2 correctly onto the locus 24. As can be seen from this figure, the guide 30 has a hole 32 that is aligned with the locus 24. Accordingly, when the patient inserts the medical container 2 through the hole 32, the patient is assured that the medical container will correctly rest on the locus 24 of the electronic device 10.

The electronic device 10 has a measurement sensor that is configured to determine the amount of medication contained in the medical container 2 that is placed onto the locus 24. Because the measurement module uses the measurement sensor to determine the weight of the medical container and its contents, the patient may be required to periodically calibrate the measurement sensor in order ensure the accurateness of the measurement sensor.

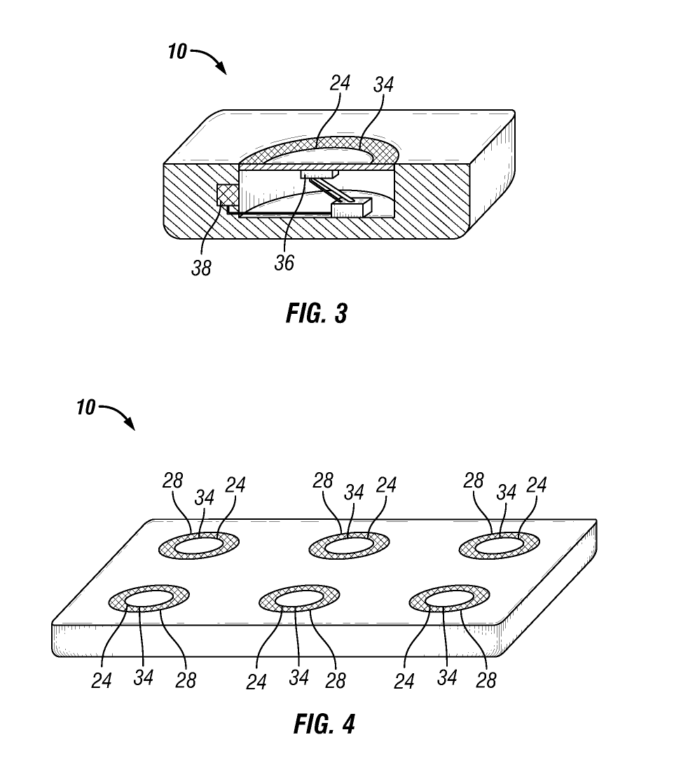

Referring to FIG. 3, in this embodiment the locus 24 comprises a weighing platter 34 that is offset from the first surface 12 of the electronic device 10. Disposed near the base or bottom of the weighing platter 34 is a measurement sensor 36. In certain embodiments, the measurement sensor 42 comprises a load cell. The load cell is a transducer that converts the force from the weight of the medical container 2 into an electrical signal which is read and converted by one or more processors on the electronic device 10 into measurement data. In addition to the measurement sensor 36, a RFID reader/writer module 38 is also disposed near the base of the weighing platter or near the perimeter of the weighing platter of the electronic device 10. The RFID reader/writer module 38 comprises a Near Field Communication (NFC), Ultra High Frequency (UHF), or Radio Frequency Identification (RFID) controller circuit and antenna which can be used to read and/or update data that is stored in the Radio Frequency (RF) component 6 of the medical container 2. In certain embodiments, a transmission bridge 40 connects the controller circuit to the antenna (not shown) that is disposed on the weighing platter 34. The transmission bridge 40 can either be a wire, such a shielded or un-shielded conductive wire or it can be a wire that is trace printed on an appropriate substrate such as printed circuit board. In the embodiment shown in FIG. 3, the transmission bridge 40 is a copper wire that is positioned to extend along the load cell in order to minimize interference with the movement of the weighing platter 34. In other embodiments, the antenna is disposed near the controller circuit or forms a part of the controller circuit itself. Additionally, one or more lights (not shown) may be placed around the perimeter of the locus 24 in order to provide a visual indication with regard to the locus 24.

Referring to FIG. 4, this embodiment is similar to the embodiment shown in FIG. 2 except that the embodiment shown in FIG. 4 comprises a plurality of locii 24.

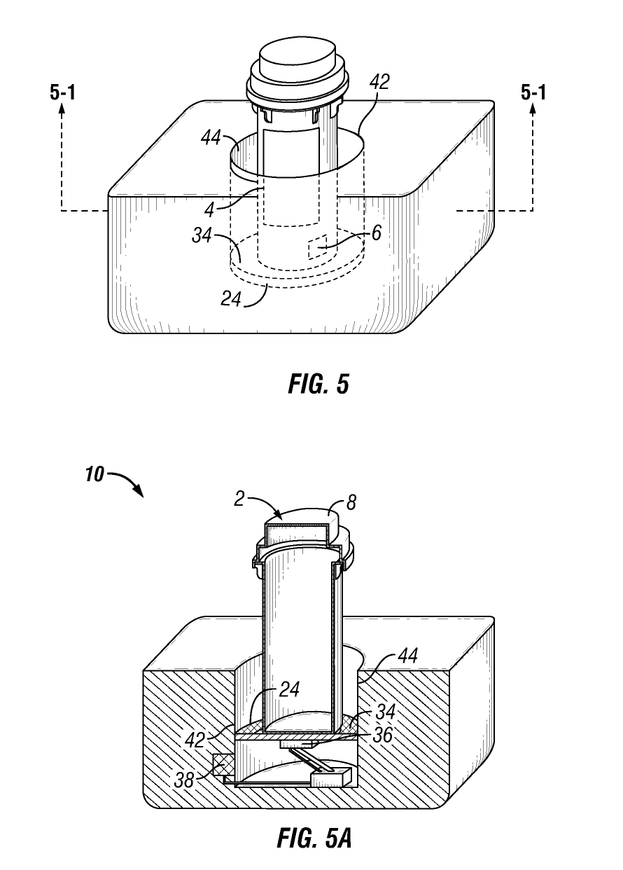

Referring to FIGS. 5 and 5A, this embodiment is similar to the embodiment shown in FIG. 2 except that the locus 24 in this embodiment comprises a weighing platter 34 disposed near the base or bottom of a receptacle 44. The receptacle 42 comprises a cavity 44 that is used to house the medical container 2 that is inserted into the receptacle 42. FIG. 5A shows the electronic device 10 with a medical container 2 inserted in the receptacle 42. In certain embodiments, a faraday cage (not shown) may surround a portion or the entire receptacle 42 thereby isolating the receptacle 42 from unwanted electrical fields.

Referring to FIG. 6, this embodiment is similar to the embodiment shown in FIG. 5 except that the embodiment shown in FIG. 6 comprises a plurality of receptacles 42.

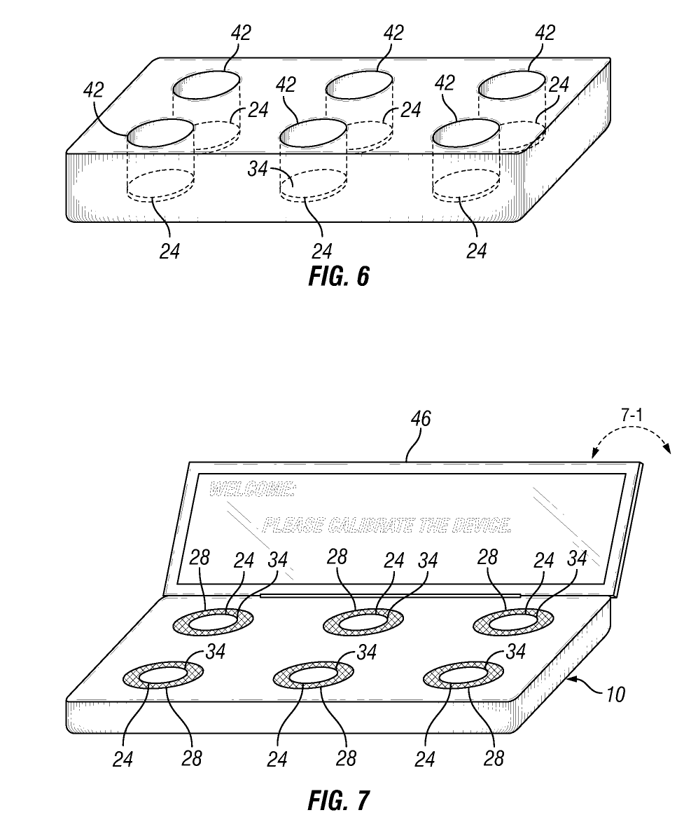

Referring to FIG. 7, this embodiment shows a graphical display 46, such as an LED, OLED, or IPS display, attached to the electronic device 10. In FIG. 7, a text message is displayed on the graphical display 46 instructing the user to calibrate the electronic device 10. In certain embodiments, the graphical display 46 can be mechanically fastened to the electronic device 10. For example, the electronic device 10 can have a male locking component that extends from a surface of the electronic device 10 and which is inserted into a female locking component located on the graphical display 46 thereby mechanically fastening the graphical display 46 to the electronic device 10. In other embodiments, the graphical display 46 and the electronic device 10 can be attached magnetically. In yet other embodiments, a combination of mechanical fasteners and magnets may be used to attach the graphical display 46 to the electronic device 10. In some embodiments, the graphical display 46 is adapted to be received into a hinge component (note shown) disposed on a surface of the electronic device thereby allowing the graphical display 46 to pivot along line 7-1. Once attached to the hinge component, the patient is able to pivot the graphical display 46 to a comfortable viewing angle.

In other embodiments, the electronic device 10 comprises a male powering component (not shown) that is adapted to be received into a female powering component located on the graphical display 46. Once interlocked, the male powering component can recharge the batteries on the graphical display 46. If the remote electronic device, which is explained in greater detail below, is used in connection electronic device 10, then the male powering component can be used to recharge the batteries of the remote electronic device as well.

While the graphical display 46 can be a removable display as described above, in some embodiments, the graphical display 46 is permanently attached to the electronic device 10. In these embodiments, the graphical display 46 is connected to the electronic device 10 by a hinge that not only allows the user to select a comfortable viewing angle, but it allows the graphical display 46 to close over the loci 24 similar to how a laptop screen closes over the laptop's keyboard.

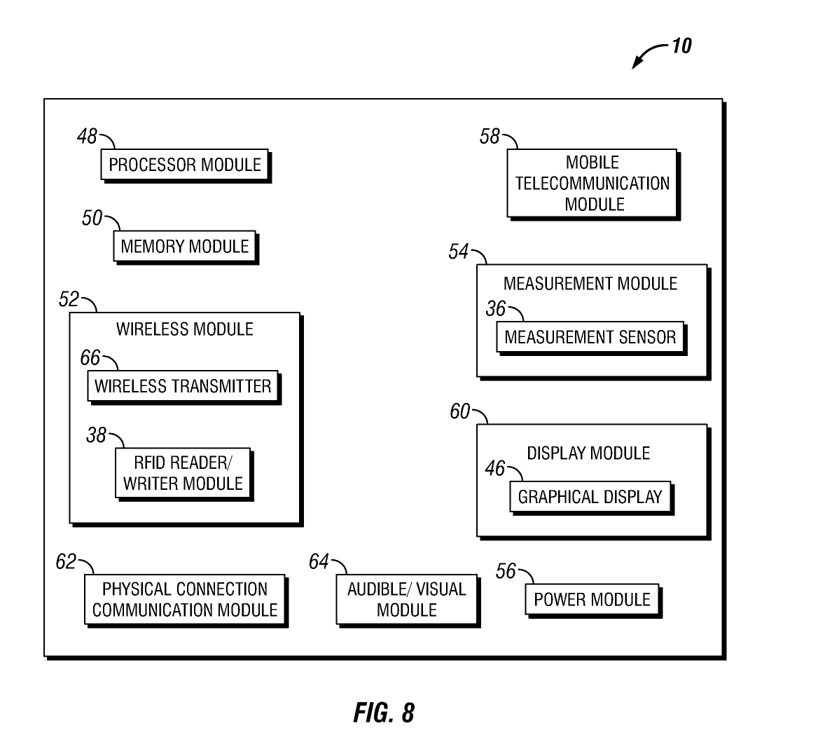

Referring to FIG. 8, the electronic device 10 is comprised of a plurality of modules. In general, these modules comprises: a processor module 48, a memory module 50, a wireless module 52, a measurement module 54, a power module 56 and, optionally, a mobile telecommunication module 58, a display module 60, a physical connection communication module 62, and/or an audible/visual module 64. While FIG. 8 depicts each module as being discreet components, it is noted that each of the modules can be accessed by and can communicate with one or more other modules shown in FIG. 8 of the electronic device 10. For example, the processor module 48 not only can access the memory module 50, but it can also access any of the other modules on the electronic device 10. Moreover, it is noted that the electronic device 10 can also include other modules that are not shown in FIG. 8 such as the calibration module, the scheduling module, and the patient alert module that will be discussed in greater detail herein.

The processor module 48 comprises any type of processor or processor assembly (e.g., assembly that comprises multiple processing elements). The processor module 48 is adapted to access the memory module 50 of the electronic device 10 to retrieve and execute instructions that are stored in the memory module 50 thereby enabling the electronic device 10 to perform the various tasks described herein. The memory module 50 comprises any type of memory device such as random access memory, read only or rewritable memory, internal processor caches, or combinations thereof that can be used to store any type of information such as the medication schedule that will be discussed in greater detail below. In certain embodiments, the processor module 48 comprises one or more processors that are configured to create or determine a medication schedule based on certain data that the electronic device 10 receives from the measurement module 54 and the Radio Frequency component 6 of the medical container 2.

The wireless module 52 comprises wireless components that allow the electronic device 10 to wirelessly communicate with other devices such as additional electronic devices 10 or the remote electronic device that will be discussed in greater detail below. Accordingly, the wireless module can comprise Bluetooth, WiFi, RFID (e.g., NFC, UHF, or combinations thereof), or other wireless technology components that enable such wireless connections. The wireless module 52 can comprise a wireless transmitter 66 or a plurality of wireless transmitters 66 that are adapted to wirelessly transmit data (e.g., measurement data and medication data) from the electronic device 10 to other devices. Additionally, the wireless module 52 can comprise wireless receivers that are adapted to receive wireless transmitted data. In certain embodiments, the wireless module 52 comprises wireless transceivers that are adapted to transmit and receive data wirelessly. For example, the wireless transmitter 66 can be a transceiver. The wireless module 52 can also include components to read and/or write information to the Radio Frequency (RF) component 6 that is disposed on the medical container 2. Therefore, in some embodiments, the wireless module 52 comprises the RFID reader/writer module 38.

The measurement module 54 comprises components that are used to measure the weight of the medical container. Accordingly, in certain embodiments, the measurement module can comprise the measurement sensor 36. As stated above, the processor module 48 can access other modules found in the electronic device 10. Therefore, in some embodiments, the processor module 48 comprises one or more processors that are configured to trigger and manage a reading of the measurement sensor 36 thereby creating measurement data regarding the amount of medication in the medical container 2. As will be discussed in greater detail below, the generated measurement data is then used perform the various tasks in the method described herein.

The power module 56 comprises power components that power the electronic device 10. These components can comprise a battery, which can be rechargeable or non-rechargeable and/or power supply that is connected to a power source via a power cable.

The mobile telecommunication module 58 comprises components that allow the electronic device 10 to wireless communicate with a cellular network. Therefore, the mobile telecommunication module can comprise LTE, GSM, CDMA, GSM, 3G, or other wireless technology components that enable such wireless connections with cellular networks.

The display module 60 comprises components, such as the graphical display 46, that allow the electronic device 10 to display graphical or text messages to the patient.

The physical connection communication module 62 comprises components that allow the electronic device 10 to communicate with other devices via a wire or cable. The communication module, therefore, can comprise USB, Firewire, Ethernet, and/or other Serial cable or Local Area Network (LAN) components that enable such wired connections.

The audible/visual module 64 can comprise components that can provide an audible or visual notification to the patient. Examples of such components include the lights and audio speaker that are described above. Alternatively, the audible module 64 can comprise a sound component, such as a sound card, with associated outputs that allow the patient to connect external speakers to the electronic device 10.

### Remote Electronic Device

A remote electronic device 68 can be used in conjunction with the electronic device 10. The remote electronic device 68 can be a handheld or wearable electronic device such as a smart phone, a personal data assistant, a tablet, a virtual/augmented reality headset, or a smart watch. Additionally, in some embodiments, the remote electronic device 68 can be a computer such as a personal computer or a computer server.

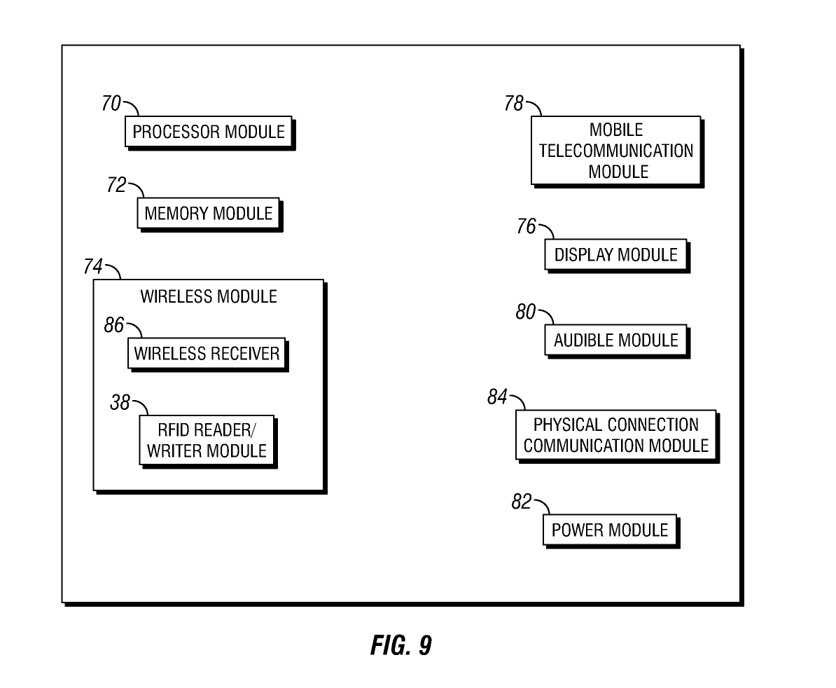

Referring to FIG. 9, similar to the electronic device 10, the remote electronic device 68 comprises a plurality of modules. While these modules can vary depending on whether the remote electronic device 68 is a handheld electronic device or a personal computer, in general, the remote electronic device comprises the following modules: a processor module 70, a memory module 72, a wireless module 74, a display module 76, a mobile telecommunication module 78, an audible module 80, a power module 82 and, optionally, a physical connection communication module 84. Moreover, it is noted that the remote electronic device 68 can also include other modules that are not shown in FIG. 9 such as the scheduling module and the patient alert module that will be discussed in greater detail herein. While FIG. 9 depicts each module as being discreet components, it is noted that each of the modules can be accessed by and can communicate with one or more other modules of the remote electronic device 68. For example, the processor module 70 not only can access the memory module 72, but it can also access any of the other modules on the remote electronic device 68.

The processor module 70 comprises any type of processor or processor assembly (e.g., assembly that comprises multiple processing elements). The processor module 70 is adapted to access the memory module 72 of the remote electronic device 68 to retrieve and execute instructions that are stored in the memory module 72 thereby enabling the remote electronic device 68 to perform the various tasks described herein. The memory module 72 comprises any type of memory device such as random access memory, read only or rewritable memory, internal processor caches, or combinations thereof that can be used to store any type of information such as the medication schedule that will be discussed in greater detail below. As will be discussed in greater detail below, in certain embodiments, the processor module 70 comprises one or more processors that are configured to create a medication schedule based on certain data that the remote electronic device 68 receives from the electronic device 10 and/or from the medical container 2.

The wireless module 74 comprises wireless components that allow the remote electronic device 68 to wirelessly communicate with other devices such as the electronic device 10. Accordingly, the wireless module can comprise Bluetooth, WiFi, RFID (e.g., NFC, UHF, or combinations thereof), or other wireless technology components that enable such wireless connections. The wireless module 74 can comprise a wireless receiver 86 or a plurality of wireless receivers 86 that are adapted to wirelessly receive data (e.g., measurement data and medication data) from other devices. Additionally, the wireless module 74 can comprise wireless transmitters that are adapted to wirelessly transmit data to other devices. In certain embodiments, the wireless module 74 comprises wireless transceivers that are adapted to transmit and receive data wirelessly. For example, the wireless receiver 86 can be a transceiver. The wireless module 74 can also include components to read and/or write information to the Radio Frequency (RF) component 6 that is disposed on the medical container 2. Therefore, in some embodiments, the wireless module 74 comprises the RFID reader/writer module 38.

The display module 76 comprises components, such as graphical display or related video components, which are well known in the art. For example, a handheld electronic device can comprise a LED, OLED, or IPS display while a personal computer can comprise a video card that can be connected to an external display such as an external LED computer monitor.

The mobile telecommunication module 78 comprises components that allow the remote electronic device 68 to wireless communicate with a cellular network. Therefore, the mobile telecommunication module can comprise LTE, GSM, CDMA, 3G, or other wireless technology components that enable such wireless connections with cellular networks.

The audible module 80 can comprise components that can provide and/or enable audio on the remote electronic device 68. Examples of such components include an audio speaker and/or a microphone. Alternatively, the audible module 64 can comprise a sound component with associated outputs that allows the user to connect the remote electronic device 68 to an external speaker.

The power module 82 comprises power components that power the remote electronic device 68. These components can comprise a battery, which can be rechargeable or non-rechargeable, and/or power supply that is connected to a power source via a power cable.

The physical connection communication module 84 comprises components that allow the electronic device 10 to communicate with other devices via a wire or cable. The communication module, therefore, can comprise USB, Firewire, Ethernet, and/or other Serial cable or Local Area Network (LAN) components that enable such wired connections.

### Method

The methods disclosed herein describe a process for providing a notification to a patient. Specifically, the methods disclosed herein are directed to providing a medication notification to a patient using the electronic device 10 described above.

Accordingly, in general, the method comprises placing the medical container 2 onto the electronic device 10. The medical container 2 comprises a Radio Frequency (RF) component 6 that comprises medication data regarding the medication that is contained within the medial container 2. When the medical container 2 is placed onto a locus 24 of the electronic device 10, the electronic device 10 is configured to (i) create measurement data regarding the amount of medication within the medial container 2, and (ii) read the medication data from the Radio Frequency (RF) component using the RF reader/writer module 38 that is disposed on or in the electronic device 10. The electronic device 10 is also configured to transmit the measurement data and the medication data to a remote electronic device 68, which can be a handheld electronic device (e.g., tablet or smartphone) or a personal computer. In some embodiments, the remote electronic device 68 then processes the medication data and measurement data it receives form the electronic device 10 to determine and create a medication schedule for the patient. While the remote electronic device 68 is the device that determines the medication schedule in these embodiments, in other embodiments, the electronic device 10 is capable of determining and creating the aforementioned medication schedule by using the medication data and measurement data. After the medication schedule has been determined, the remote electronic device 68 can then activate a medication alert based at least in part on the medication data thereby reminding the patient to take his or her medication at a prescribed time. In certain embodiments, the medication alert comprises activating a light source, an audio speaker, and/or a display on the remote electronic device 68 (collectively, “Patient Notification Components”). For example, if the display is activated, then a graphical or text output can be shown on the display reminding the patient when to take the medication in the medical container 2 or, alternatively, it can instruct the patient to take the medication in the medical container 2. The graphical or text output that can be shown in the display is non-limiting. For example, in certain embodiments, the output can not only show the patient when the next dose of the medication is to be taken, but it can also display the number of prescriptive pills that the patient is required to take. In addition to activating the Patient Notifications Components on the remote electronic device 68, in some embodiments, a speaker and/or light source on the electronic device 10 can also be activated simultaneously with the activation of the Patient Notification Components or after the activation of such components. In the event that the speaker and/or light source on the electronic device 10 are activated after the activation of the Patient Notification Components, then the activation of the speaker and/or light source on the electronic device 10 can be based off of a preset time interval that is selected by the user.

It is noted that the transmission of any data, such as the aforementioned medication data and/or measurement data, from the electronic device 10 to the remote electronic device 68 can use one or more of the following modules: (i) the processor module 48, memory module 50, wireless module 52, mobile telecommunication module 58, or physical connection communication module 62 of the electronic device 10; and (ii) the processor module 70, memory module 72, wireless module 74, mobile telecommunication module 78, or physical connection communication module 84 of the remote electronic device 68. Accordingly, any combination of components in those modules, such as wireless transmitters and receivers, can be used to transmit data between the electronic device 10 and the remote electronic device 68.

After the medication alert has been activated and the patient has taken his or her medication from the medical container 2, then the patient will place the medical container 2 back onto the locus 24 so that the electronic device 10 may determine that amount of medication remaining in the medical container 2. In certain embodiments, this is accomplished by generating new measurement data regarding the amount of medication within the medical container 2 and comparing the newly generated data with the previously generated measurement data. After the electronic device 10 has determined the amount of medication left in the medical container 2, it can then store the updated information in the memory module 50 of the electronic device 10 and/or it can transmit such data to the remote electronic device 68. In certain embodiments, the electronic device 10 can also update the data that is stored in the Radio Frequency (RF) component 6 of the medical container 2 based on the updated measurement data. For example, the electronic device 10 can update the data stored in the Radio Frequency (RF) component 6 to reflect the actual number of prescriptive pills left in the medical container 2.

In certain embodiments, the method disclosed herein further comprises transmitting certain data related to the patient's intake of the prescribed medication to a remote data network. The data that can be transmitted from the electronic device 10 to the remote data network is not meant to be limiting and can include, without limitation, the measurement and medication data as well as a simple confirmation that the patent has taken the prescribed medication at the correct dosage and at the prescribed time.

In certain embodiments, the remote data network comprises one or more computer servers that are configured to electronically award rewards points based on the transmitted data. The computer servers, which comprise a processor module and a memory module, can be used to associate a particular patient to a particular rewards account. After the electronic device 10 has determined that the correct number of prescriptive pills have been removed from the medical container 2 based on the medication schedule, the electronic device 10 can transmit certain data to the remote data network thereby triggering the network to award reward points to the patient's rewards account. In certain embodiments, the patient can then use the reward points that he or she earns to achieve discounts with various retailers.

in some embodiments, the remote data network can be used to transmit a text message or a Short Message Service (SMS) message to the remote electronic device 68 or the electronic device 10 if the electronic device 10 has a graphical display 46.

In yet other embodiments, that data that is transmitted to the remote data network can be used to determine whether a particular medication could potentially have an adverse interaction with another medication that the patient is currently taking. For example, if the patient has been prescribed a plurality of medications, then the electronic device 10 can send the medication data that is read from the Radio Frequency (RF) component 6 of the medical containers 2 to the remote data network in order to determine whether the prescribed medications have any potential adverse interactions with one another. Accordingly, in this embodiment, the remote data network comprises a database that contains information with regard to any potential adverse reactions between prescribed medications (“Adverse Interaction Database”). If a potential adverse interaction is found, then the remote data network can then instruct the electronic device 10 to activate an alert, such as displaying an alert on the display of the remote electronic device 68 and playing an audible alert on the electronic device 10, thereby notifying the patient of the potential adverse drug interactions.

While the aforementioned remote data network typically comprises the Adverse Interaction Database, in certain embodiments, the Adverse Interaction Database can be stored on the memory module 50 of the electronic device 10 and/or the memory module 72 of the remote electronic device 68. Accordingly, in these particular embodiments, transmission of the medication data to the remote data network is not required. Rather, the remote data network can simply be used to update the Adverse Interaction Database stored on the electronic device 10 and/or the remote electronic device 68.

In certain embodiments, a combination of the remote data network, the electronic device 10, the remote electronic device 68, and the medical container 2 is used to store information regarding the patient and the patient's medication. For example, a portion of the data which would otherwise be stored on the Radio Frequency (RF) component 6 of the medical container 2 could be stored in a computer that comprises the remote data network while other parts of the data can be stored on the electronic device 10, the remote electronic device 68, and/or the Radio Frequency (RF) component 6 of the medical container 2. These embodiments are useful in situations when the overall storage capacity of the Radio Frequency (RF) component 6 is limited.

it should be noted that any transmission of data between the electronic device 10, the remote electronic device 68, and/or the remote data network can be encrypted using techniques that are known to those skilled in the art.

In another embodiment of the disclosed method, the remote electronic device 68 is used to read the medication data from the Radio Frequency component 6 of the medical container 2 in lieu of using the electronic device 10. The remote electronic device 68 would then take the medication data that it receives from the medical container 2 as well the measurement data that it receives from the electronic device 10 to create or determined the medication schedule. However, in some embodiments, the medication schedule can be created by the electronic device 10 by having the remote electronic device 68 transmit the medication data to the electronic device 10 and having the electronic device 10 create or determine the medication schedule based on the measurement data and the medication data.

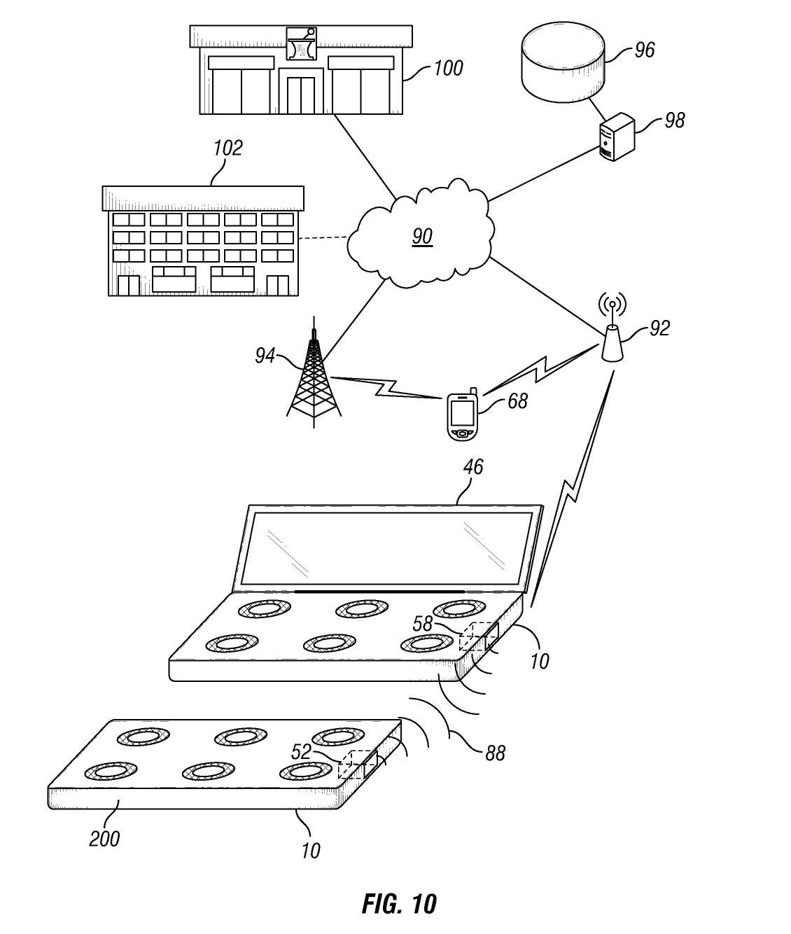

Referring to FIG. 10, in this illustration, a plurality of electronic devices 10 are connected to one another via a wireless link 88 such as WiFi or Bluetooth. The electronic device 10 comprising the graphical display 46 is connected to a remote data network 90, such as a cloud network or the Internet, via the electronic device's wireless module 52 and/or its mobile telecommunication module 58. Accordingly, the electronic device 10 can connect to the remote data network 90 by WiFi or by a cellular network. If WiFi is used, then the electronic device 10 is wirelessly connected to a local wireless network via a wireless access point 92. The wireless access point 92 is connected to the remote data network 90 using components that are known in the art such as a cable modem or a DSL modem. If a cellular network is used to connect the electronic device 10 to the remote data network 90, then the electronic device 10 is wirelessly connected to one or more cellular towers 94 that are located in the vicinity of the electronic device 10 and which are connected to the remote data network 90 using components that are known in the industry. The electronic device 10 can access at least one database 96 through at least one computer server 98 via the remote data network 90. For example, the electronic device 10 could access the database in order to obtain and/or provide relevant information with regard to the prescribed medication, the patient's intake of the medication, and/or the patient's rewards account. Additionally, a pharmacy 100, a physician's office 102, and/or other authorized third party may be connected to the remote data network 90 so that the patient's pharmacist, physician, and/or third party (not shown) can monitor the patient's intake of the prescribed medication.

FIG. 10 depicts the remote data network 90 communicating to the remote electronic device 68 via the wireless access point 92 and/or the cellular towers 94. As described elsewhere herein, the remote data network 90 can be used to send a text message, a SMS message, or an email message to the remote electronic device 68 in order to provide the patient with up-to-date information regarding his or her prescribed medication or to remind the patient to take his or her medication. It should be noted that while FIG. 10 only shows a single remote electronic device 68 being connected to the remote data network 90, a plurality of remote electronic devices 68 may also be connected to the network as well. Accordingly, those devices can also be configured to receive the same text message, SMS message, or email message from the remote data network 90 as described above.

In certain embodiments, the electronic device 10 can order additional medication for the patient by automatically contacting the patient's pharmacy 100 when the patient medication is running low.

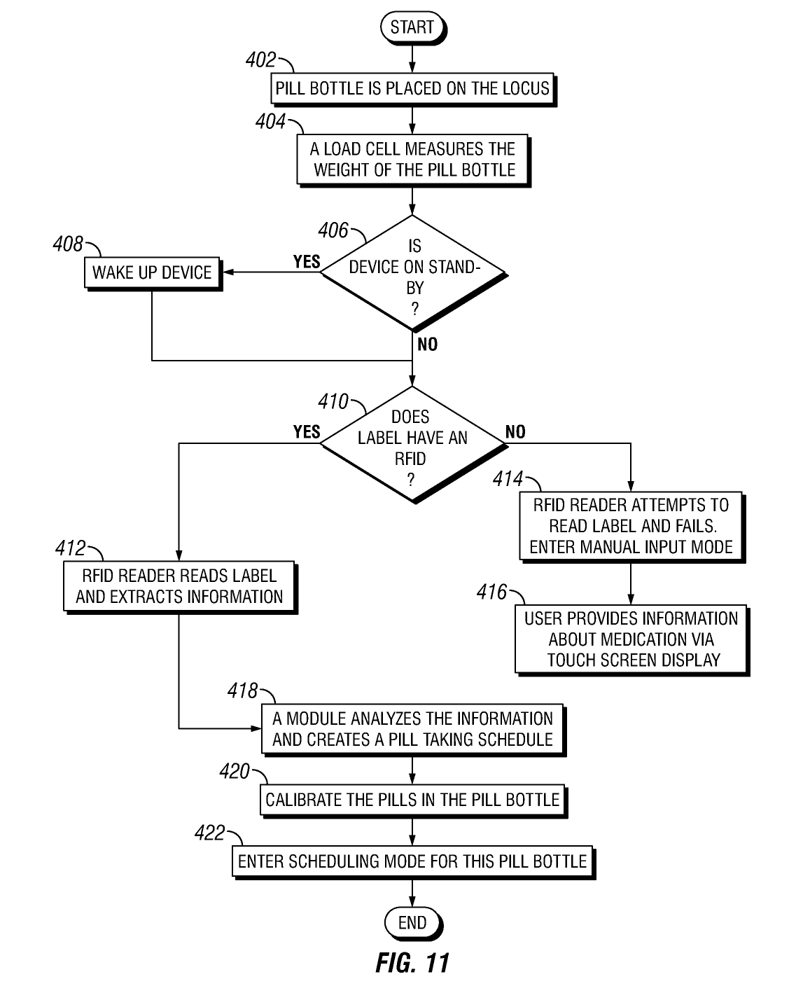

Referring to FIG. 11, in this embodiment, the method is initiated in step 402 by the introduction of a medical container 2, such as a pill bottle, onto a locus 24 of the electronic device 10. Once placed on the locus 24, a load cell will measure the weight of the pill bottle. The change in weight on the load cell signifies to the electronic device 10 that a pill bottle has been placed onto the locus 24. If the device in in stand-by mode 406, then the electronic device 10 exits stand-by mode and wakes itself up in step 408.

The electronic device 10 then determines in step 410 whether the pill bottle has a Radio Frequency (RF) component 6. If the pill bottle does have a Radio Frequency (RF) component 6, then, in step 412, the electronic device 10 uses its RF reader/writer module 38 to extract information regarding the prescribed medication from the Radio Frequency (RF) component 6. As stated above, the information contained in the Radio Frequency (RF) component 6 can be any information such as, without limitation, the name of the medication and dosage information, the total amount of medication or pills in the pill bottle, the number of pills to be taken, the duration that the patient has to take the medication, the expiration date of the medication, side effects of the medication, known drug interactions, and any other information that might be useful to the patient, pharmacist, or patient's physician.

If the electronic device 10 is unable to determine whether the pill bottle has a Radio Frequency (RF) component 6 or it fails to detect such a component, then, in step 414, the electronic device 10 enters into manual input mode. In manual input mode, the patient will manually input the required medication information into the electronic device 10 and/or the remote electronic device 68. In certain embodiments, this can be accomplished using the display module 60, 76 of the electronic device 10 or the remote electronic device 68, respectively.

After the appropriate information has been entered into the electronic device 10 and/or the remote electronic device 68, one or both of the devices will then analyze the measurement data obtained in step 404 as well as the medication data that was either retrieved from the Radio Frequency (RF) component 6 of the pill bottle in step 412 or manually entered by the patient in step 414 in order to create a medication schedule in step 418.

After the medication schedule has been created, the electronic device 10 then uses a calibration module to calibrate and store in memory the current weight of the pill bottle in step 420. After calibration, the electronic device 10 enters a scheduling mode for the pill bottle in step 422 based on the created medication schedule and provides the patient with the medication alerts at the prescribed times.

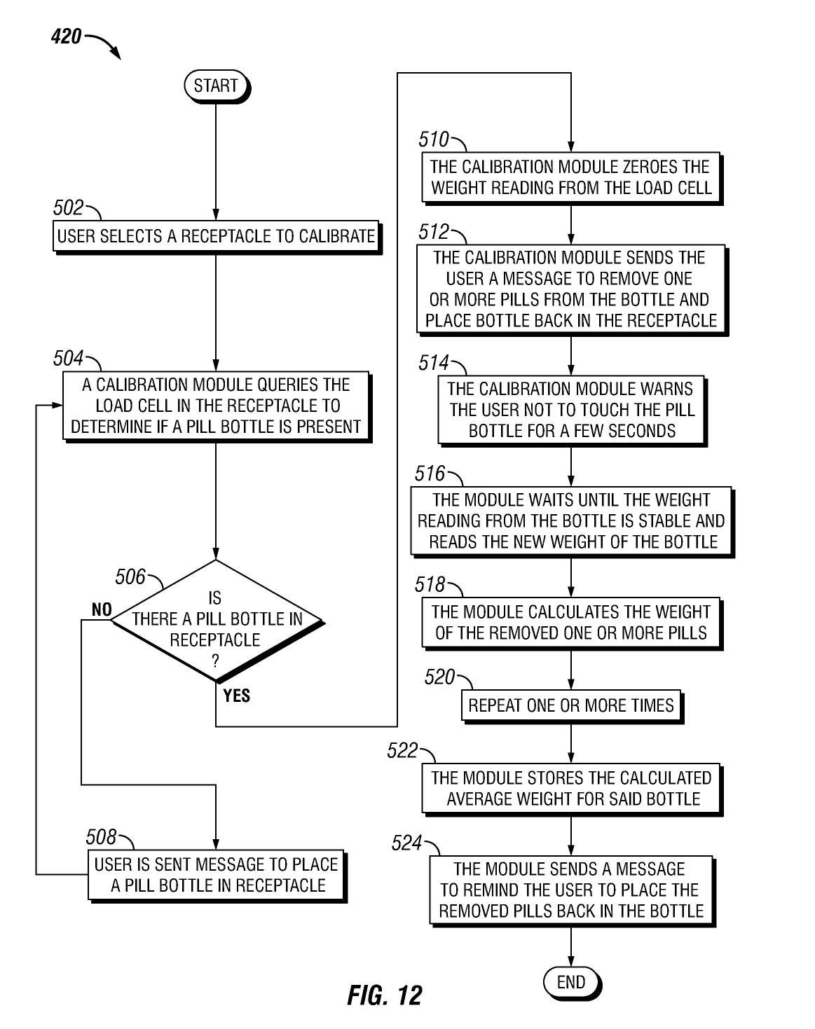

Referring to FIG. 12, calibration of the medical container 2 is used to determine the average weight of a pill in the medical container 2. This is useful since typically there is no standard pill weight for any given medication because the weight of a pill is not necessarily related to the amount of active medication within the pill. For example, a pill with 100 mg of active medication can weigh the same as a pill with 200 mg of active medication. This is due to the fact that the pill with 100 mg of active medication can have a greater amount of filler product than the pill with 200 mg of active medication.

Calibration begins in step 502 by the patient placing the medical container 2, such as a pill bottle, onto a locus 24 of the electronic device 10 and initiating the calibration process. In certain embodiments, the calibration process can be initiated by the user by either using the display module 60, 76 of the electronic device 10 or the remote electronic device 68, respectively, or by simply pushing down on the medical container 2 thereby activating the bad cell that is disposed at the bottom of the locus 24. The calibration module of the electronic device 10 then queries the load cell in step 506 to determine whether these is a pill bottle on the locus 24. If no pill bottle is detected, then, in step 508, the calibration module notifies the patient that no pill bottle is present on the locus 24 via a graphical, text, and/or audio notification on the electronic device 10 and/or the remote electronic device 68. The patient or user is then instructed to place a pill bottle onto the locus 24 that is being calibrated and the process returns to step 504. After the calibration module determines that a pill bottle has been placed onto the appropriate locus 24, the electronic device 10 will instruct the patient to not touch the pill bottle for a specified time interval during which time the calibration module zeros the weight reading from the load cell in step 510. The zeroing of the pill bottle weight in this step also comprises the calibration module taking the reading of the weight value as a base value. In step 512, the calibration module will then send the patient a notification, such as a graphical, text, and/or audio notification on the electronic device 10 and/or the remote electronic device 68, to remove one or more pills from the pill bottle and to place the pill bottle back onto the locus 24. After the pill bottle has been returned onto the locus 24, the electronic device 10 instructs the patient to not touch the pill bottle for a specified time interval in step 514. The calibration module waits until the weight reading from the pill bottle is stable and then reads the new weight from the load cell in step 516. The calibration module will then calculate the weight of the removed pills in step 518. The calibration module can repeat the measurement any number of times until an accuracy requirement is met in step 520.

After the average weight of the removed pills have been calculated, the calibration module will then determine the total weight of the medication in the pill bottle based on the average weight of each pill, which was calculated in step 518, and the number of pills in the pill bottle which was provided in the medication data. Once the total weight of the medication has been calculated, the calibration module will then, in step 522, store that calculated weight in the memory module of the electronic device 10 so that it may be used to determine the number of pills being removed from the pill bottle. After step 522, the calibration module will send a notification to the patient, such as a graphical, text, and/or audio notification on the electronic device 10 and/or the remote electronic device 68, instructing the patient to return the removed pills back into the pill bottle in step 524.

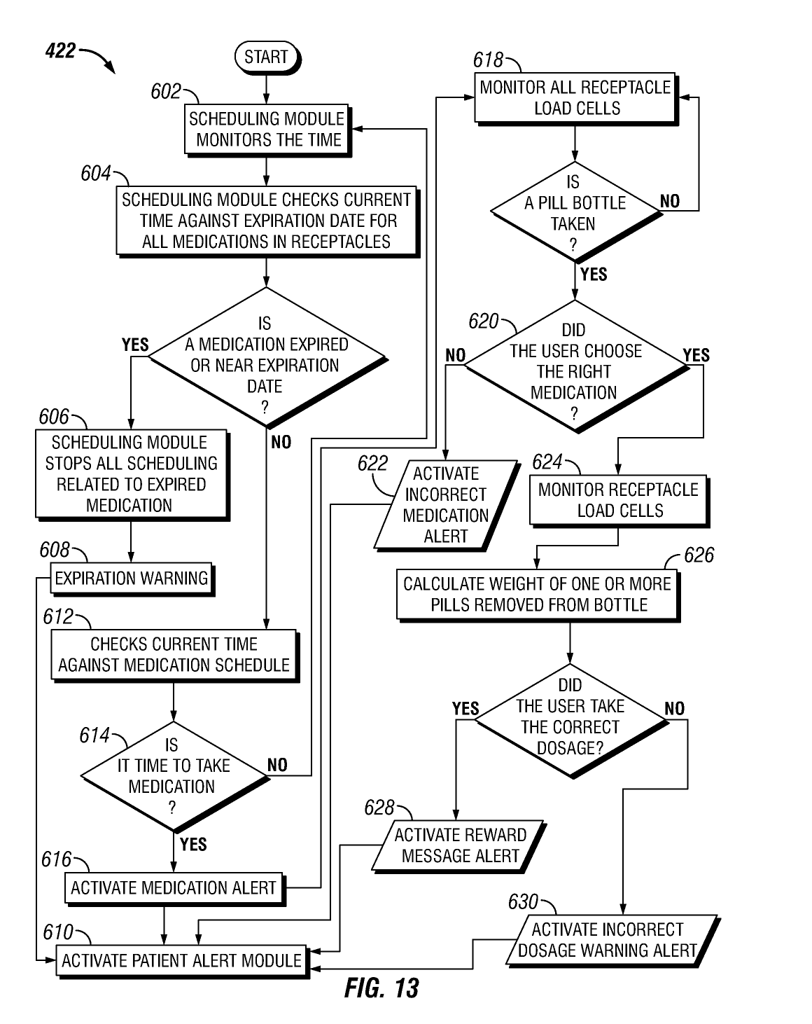

Referring to FIG. 13, in certain embodiments, the electronic device 10 and/or the remote electronic device 68 comprises a scheduling module that is used to activate a patient alert module. In step 602, the scheduling module monitors the time so that the electronic device 10 can provide the patient with a medication alert at the appropriate time based on the created medication schedule. Additionally, in order to avoid any potential issues with expired medications, the scheduling module in step 604 checks the current time against the expiration date for any medication that has been placed on the locus 24 of the electronic device 10. If a medication is expired or near its expiration date, then the scheduling module will stop all scheduling activities related to the medication in step 606 while also sending an expiration warning to the patient in step 608 by activating the patient alert module of the electronic device 10 and/or the remote electronic device 68 in step 610.

The patient alert module, in certain embodiments, manages the communication of all relevant alarms, messages, and communications with the patient or use of the electronic device 10. As with the other modules on the electronic device 10 and/or the remote electronic device 68, the patient alert module can access and activate other modules that are on those devices. For example, the patient alert module on the remote electronic device 68 can access the display module 76 on that device in order to display a graphical or text alert to the patient indicating that a specific medication is expired and where to find the medical container 2 on the electronic device 10. Additionally, the patient alert module on the remote electronic device 68 can also access the audible/visual module on the electronic device 10 in order to activate a speaker and/or a light on the electronic device 10 thereby assisting the patient with identifying which pill bottle contains the expired medication. Moreover, the patient alert module can also use the various communication modules that are on the electronic device 10 and/or the remote electronic device 68 to communicate with the remote data network shown in FIG. 10 so that expiration alert can also be communicated with the patient's pharmacist, physician, and/or other authorized third party.

Referring back to FIG. 13, if the medication is not expired, then the current time is checked against the medication schedule in step 612 to determine whether it is time for the patient to take his or her medication. If the scheduling module determines that it is time for the patient to take the medication, then the scheduling module will activate the medication alert in step 616 which then activates the patient alert module in step 610. The patient alert module can then provide the patient with any relevant information regarding the medication by using one or more modules on the electronic device 10 and/or remote electronic device 68. For example, the display module 78 on the remote electronic device 68 can be used to display any type of information including, without limitation, the medication name, the amount to be taken, any special requirements concerning the medication, and a graphical alert that the medication should be taken at that time. If the scheduling module determine that it is not time for the patient to take his or her medication, then the process returns to step 602.

In certain embodiments, the patient alert module can activate a notification on the electronic device 10 and/or the remote electronic device 68 at a predetermined time before the medication is due to be taken by the patient. This early warning notification can then be followed by a subsequent notification that is activated at the time when the patient is to take his or her medication.

Referring back to FIG. 13, after the patient alert module has been activated in step 610, the electronic device 10 will monitor the locus 24, in step 618, to determine whether a pill bottle has been removed from the electronic device 10. If a pill bottle was removed from the electronic device 10, then the load cell on which the pill bottle was placed would register a large drop in weight. This drop in weight would be a signal to the electronic device 10 that a pill bottle has been removed from the device. If the electronic device 10 determines that a pill bottle has not been removed from the electronic device 10, then the process returns to step 618.

If the electronic device 10 determines that a pill bottle has been removed from the electronic device 10, then the scheduling module will then determine whether the patient chose the correct pill bottle in step 620. If the patient chose the incorrect pill bottle, then an incorrect medication alert is activated in step 622 which then activates the patient alert module in step 610. The patient alert module can then use the one or more modules on the electronic device 10 and/or the remote electronic device 68 to notify the patient that the incorrect pill bottle was taken and that the pill bottle should be placed back onto the electronic device 10 at the locus 24 from which the incorrect pill bottle was removed. Alternatively, if the electronic device 10 determines that the correct pill bottle has been removed from the electronic device 10, then the scheduling module will monitor the load cell values in step 624 and will wait for the patient to replace the pill bottle onto the locus 24 from which it was removed. After the pill bottle has been placed back onto the appropriate locus 24, the scheduling module can calculate the loss in weight due to the removal of medication pill from the bottle in step 626. If it is determined that the patient took the correct dosage, then a reward message alert is activated in step 628 which then activates the patient alert module in step 610. The patient alert module can then provide the patient with a notification that the correct medication and dosage was taken using one or more module on the electronic device 10 and/or remote electronic device 68. Additionally, in some embodiments, the patient alert module can also transmit to the remote data network that the patient has taken the correct dosage and medication in order to provide up-to-date information with regard to the patient's medication intake to relevant and third authorized parties. If it is determined that the patient took the incorrect dosage, then an incorrect dosage warning alert is activated in step 630 which then activates the patient alert module in step 610. The patient alert module can then provide the patient with a notification that the incorrect medication and dosage was taken using one or more modules on the electronic device 10 and/or remote electronic device 68. Additionally, in some embodiments, the patient alert module can transmit to the remote data network that the patient has taken the incorrect dosage of medication thereby alerting relevant and authorized third parties (e.g., patient's pharmacist and physician) that the patient has taken the incorrect dosage. Therefore, in these embodiments, the patient's pharmacist and/or physician who receive the alert can then take appropriate action with regard to their patient.

While specific embodiments have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A method for providing a medication notification to a patient comprising:
placing a medical container comprising a Radio frequency (RF) component onto an electronic device, wherein said Radio Frequency (RF) component comprises medication data regarding a medication contained within the medical container and wherein said electronic device comprises: (i) a locus for positioning the medical container, (ii) a measurement sensor for determining the weight of the medication, (iii) one or more processors configured to trigger and manage a reading of the measurement sensor to create measurement data regarding the amount of medication in the medical container, (iv) a transmitter for wirelessly transmitting the measurement data and medication data (v) a RF reader/writer module configured to receive the medication data, and, optionally, at least one of the following: an audio speaker or a light source;
creating measurement data regarding the amount of medication within the medical container;
transmitting the measurement data to a remote electronic device wherein the remote electronic device comprises: (a) a wireless receiver configured to receive the measurement data; (b) one or more processors configured to determine a medication schedule and activate a medication alert based at least in part on the measurement data and the medication data; (c) a display; (d) a wireless receiver configured to receive the medication data and, optionally, at least one of the following: an audio speaker or a light source;
determining a medication schedule based at least in part on the measurement data and the medication data; and
activating the medication alert when the patient is required to take the medication as determined by the medication schedule, wherein the medication alert comprises activating at least one of the light source, the audio speaker, or component (c) on the remote electronic device and, optionally, activating at least one of the speaker or the light source on the electronic device.

2. The method according to claim 1, wherein the method further comprises transmitting the measurement and medication data to a remote data network wherein the remote data network comprises a computer server that comprises a processor that is configured to electronically award rewards points based on the transmitted measurement and medication data to a rewards account associated with the patient that is stored in memory on the computer server.

3. The method according to claim 1, wherein activating component (c) comprises displaying a graphical or text output on component (c) of the remote electronic device.

4. The method according to claim 1, wherein the Radio Frequency (RF) component comprises a Near Field Communication (NFC), Ultra High Frequency (UHF), or Radio Frequency Identification (RFID) transponder chip.

5. The method according to claim 1, wherein the electronic device is a mobile electronic device or a computer.

6. The method according to claim 1, wherein the locus comprises a receptacle.

7. The method according to claim 1, wherein the medication data further comprises prescription data.

8. The method according to claim 1, wherein the component (v) of the electronic device is configured to read and update the medication data on the Radio Frequency (RF) component.

9. The method according to claim 1, wherein the RF reader/writer module comprises a Near Field Communication (NFC), Ultra High Frequency (UHF), or Radio Frequency identification (RFID) controller circuit and antenna.

10. The method according to claim 1, wherein components (a) and (d) of the remote electronic device are the same component.

11. The method according to claim 1, wherein the storage device comprises a plurality of locii.

12. The method according to claim 11, wherein at least one of the locii comprises a light source and wherein activating at least one of the speaker or the light source on the electronic device comprises activating the light source one at least one of the locii.

13. A method for providing a medication notification to a patient comprising;
placing a medical container comprising a Radio frequency (RF) component onto an electronic device, wherein said Radio Frequency (RF) component comprises medication data regarding a medication contained within the medical container and wherein said electronic device comprises; (i) a locus for positioning the medical container, (ii) a measurement sensor for determining the weight of the medication, (iii) one or more processors configured to trigger and manage a reading, of the measurement sensor to create measurement data regarding the amount of medication in the medical container, (iv) a transmitter for wirelessly transmitting the measurement data and medication data, and, optionally, at least one of the following: an audio speaker or a light source;
creating measurement data regarding the amount of medication within the medical container;
using a remote electronic device to read the measurement and medication data from the electronic device wherein the remote electronic device comprises: (a) a wireless receiver configured to receive the measurement data; (b) one or more processors configured to determine a medication schedule and activate a medication alert based at least in part on the measurement data and the medication data; (c) a display; (d) a RF reader/writer module configured to receive the medication data, and, optionally, at least one of the following: an audio speaker or a light source;
reading the medication data from the Radio Frequency (RF) component;
determining a medication schedule based at least in part on the measurement data and the medication data; and
activating the medication alert when the patient is required to take the medication as determined by the medication schedule, wherein the medication alert comprises activating at least one of the light source, the audio speaker, or component (c) on the remote electronic device and, optionally, activating at least one of the speaker or the light source on the electronic device.

14. The method according to claim 13, wherein the method further comprises transmitting the measurement and medication data to a remote data network wherein the remote data network comprises a computer server that comprises a processor that is configured to electronically award rewards points based on the transmitted measurement and medication data by a processor to a rewards account associated with the patient that is stored in memory on the computer server.

15. The method according to claim 13, wherein activating component (c) comprises displaying a graphical or text output on component (c) of the remote electronic device.

16. The method according to claim 13, wherein the Radio Frequency (RF) component comprises a Near Field Communication (NFC), Ultra High Frequency (UHF) or Radio Frequency Identification (RFID) transponder chip.

17. The method according to claim 13, wherein the electronic device is a mobile electronic device or a computer.

18. The method according to claim 13, wherein the locus comprises a receptacle.

19. The method according to claim 13, wherein the medication data further comprises prescription data.

20. The method according to claim 13, wherein the RF reader/writer module comprises a Near Field Communication (NFC), Ultra High Frequency (UHF), or Radio Frequency Identification (RFID) controller circuit and antenna

21. The method according to claim 13, wherein components (a) and (d) of the remote electronic device are the same component.

22. The method according to claim 13, wherein the storage device comprises a plurality of locii.

23. The method according to claim 23, wherein at least one of the locii comprises a light source and wherein activating at least one of the speaker or the light source on the electronic device comprises activating the light source one at least one of the locii.
